(19) United States
(12) Patent Application Publication
(10) Pub. No.: US 2012/0192078 A1
(43) Pub. Date: Jul. 26, 2012

(54) METHOD AND SYSTEM OF MOBILE VIRTUAL DESKTOP AND VIRTUAL TRACKBALL THEREFOR

(75) Inventors: KUN BAI, Elmsford, NY (US); Zhi Guo Gao, Beijing (CN); Leslie Shihua Liu, White Plains, NY (US); James Randal Moulic, Poughkeepsie, NY (US); Dennis Gerard Shea, Ridgefield, CT (US)

(73) Assignee: INTERNATIONAL BUSINESS MACHINES, Armonk, NY (US)

(21) Appl. No.: 13/014,423

(22) Filed: Jan. 26, 2011

(51) Int. Cl. G06F 3/048; G06F 15/16

(52) U.S. Cl. 715/740

(57) ABSTRACT

A method and system for remote control of a desktop computer from a hand held mobile device having a display. A desktop screen image is split into regions, showing a part of a region on the screen of the mobile device. A virtual trackball is provided which includes a location button and trackball button. The location button operates as a virtual mouse which can be used to click on hotspots and when the virtual mouse cursor is about to cross the boundary of screen regions the next available screen region will smoothly slide onto the device screen. The trackball button is useable to switch between hotspots which can be identified through local image analysis.

### BACKGROUND

1. Technical Field

The present disclosure relates to communication devices, and, more particularly, to hand-held mobile communication devices.

2. Discussion of Related Art

Many leading technology companies have provided approaches to remotely control another computer. One example is Virtual Network Computing (VNC®) which provides a graphical desktop sharing system that uses a remote frame buffer (RFB®) protocol to remotely control another computer. (VNC and RFB are registered trademarks of RealVNC Ltd.) Keyboard and mouse events are transmitted from one computer to another, relaying graphical screen updates in the other direction over a network. Another example is Windows® Remote Desktop Service, which is one of the components of Microsoft® Windows® (both server and client versions), that utilizes a proprietary remote desktop protocol (RDP) which allows a user to access applications and data on a remote computer over a network. (Microsoft and Windows are registered trademarks of Microsoft Corporation.)

As hand-held mobile devices become more popular for enterprise and consumer applications, there is an emerging trend to be able to use hand-held mobile phones to remotely access desktop computers, to enable client-server and cloud computing capabilities such that data and applications can be virtually carried on the hand-held mobile devices, all without the necessity of modification to desktop computer applications.

### BRIEF SUMMARY

In accordance with exemplary embodiments of the present disclosure, an input system for hand held mobile device that can control a remote desktop service is provided. A whole desktop screen is split into several regions, only showing one part of a region on the screen of the mobile device. A virtual trackball is provided which includes a location button and trackball button. The location button operates as a virtual mouse which can be used to click on hotspots and when the virtual mouse cursor is about to cross the boundary of screen regions the next available screen region will smoothly slide onto the device screen. The trackball button is useable to quickly switch between hotspots which can be identified through local image analysis.

In accordance with an exemplary embodiment, a method for remote control of a desktop computer from a mobile device having a display includes receiving by the mobile device an image representation of a user interface of the desktop computer, scanning the image representation to detect one or more interacting objects of the image representation, generating on the display a display image having one or more of the interacting objects of the image representation, and controlling the desktop computer by interacting with the one or more of the interacting objects of the display image and sending control information back to the desktop computer.

According to an exemplary embodiment a non-transitory computer program storage device embodying instructions executable by a processor to perform remote control of a desktop computer from a hand held mobile device having a display includes instruction code for receiving by the mobile device an image representation of a user interface of the desktop computer, instruction code for scanning the image representation to detect one or more interacting objects of the image representation, instruction code for generating on the display a display image having one or more of the interacting objects of the image representation, and instruction code for controlling the desktop computer by interacting with the one or more of the interacting objects of the display image and sending control information back to the desktop computer.

According to an exemplary embodiment a mobile device for remote control of a desktop computer includes a hand-held mobile computer processing device having a display, and a non-transitory computer program storage device configured to interact with the hand-held mobile computer processing device to provide a user an ability to control a remote desktop computer by the mobile device, the non-transitory computer program storage device including instruction code for receiving by the mobile device an image representation of a user interface of the desktop computer, instruction code for scanning the image representation to detect one or more interacting objects of the image representation, instruction code for generating on the display a display image having one or more of the interacting objects of the image representation, and instruction code for controlling the desktop computer by interacting with the one or more of the interacting objects of the display image and sending control information back to the desktop computer.

According to an exemplary embodiment a method for remote control of a desktop server from a mobile device having a touch screen display screen for displaying an image of the desktop server and for desired entry input by a user is provided. The method includes receiving an image from the remote desktop server, splitting an image display on the touch screen display screen into several regions, only one region being shown on the touch screen display screen at a time, identifying and storing locations in a region of one or more interacting objects using local image analysis, configuring the display on the touch screen display screen such that a region displayed is changeable using identified locations, providing a virtual trackball configured for changing hotpots, the virtual trackball having clickable icons for controlling a cursor on the touch screen display screen, and sending back cursor position and click-action to the desktop computer.

### BRIEF DESCRIPTION OF THE SEVERAL VIEWS OF THE DRAWINGS

Exemplary embodiments of the present disclosure will be more clearly understood from the following detailed description taken in conjunction with the accompanying drawings in which:

FIG. 1 depicts a mobile device for controlling a remote computer/server in accordance with an exemplary embodiment.

FIG. 2 depicts a block diagram of components of the mobile device in accordance with an exemplary embodiment.

FIG. 3 depicts a block diagram of various software modules executable by a processor of the mobile device in accordance with an exemplary embodiment.

FIG. 4 provides a sequence of operational steps in accordance with an exemplary embodiment.

FIG. 5 depicts an original image display divided into regions for mobile screen display in accordance with an exemplary embodiment.

FIGS. 6A, 6B and 6C depict mobile device screen displays, with FIGS. 5B and 5C including a displayed virtual trackball.

FIGS. 7, 8 and 9 depict the operation of software modules in accordance with an exemplary embodiment of the present disclosure.

### DETAILED DESCRIPTION

Reference will now be made in detail to the exemplary embodiments, examples of which are illustrated in the accompanying drawings, wherein like reference numerals refer to the like elements throughout.

A significant challenge for hand-held mobile devices is to be “user friendly”. A key aspect of a user friendly device lies in its user interface (UI) and input system. For example, the screen size of hand-held mobile devices is always much smaller than conventional personal computer (PC) desktops. When a whole desktop screen is shown on the screen of the hand-held mobile devices, the buttons, input boxes or icons (i.e., the clickable areas) become too small to be located using a keyboard or a trackball on the mobile devices. It also becomes difficult for a user to control the trackball to click a small button accurately.

Hotspots, are locations on a touchpad that indicate user intentions other than pointing. For example, a finger can be moved along a right edge of a touchpad to control the scroll of the window that has focus vertically or moving the finger on the bottom of the touchpad to control the scroll of the window that has focus horizontally. Some mobile devices, such as the Nokia® E61 mobile phones or Blackberry® mobile phones, have a trackball that can easily capture hotspots (Nokia is a registered trademark of Nokia Corporation. Blackberry is a registered trademark of Research in Motion Limited.) However, such hotspots only exist in the native applications or built-in browsers, and are not available for use in remote desktop services.

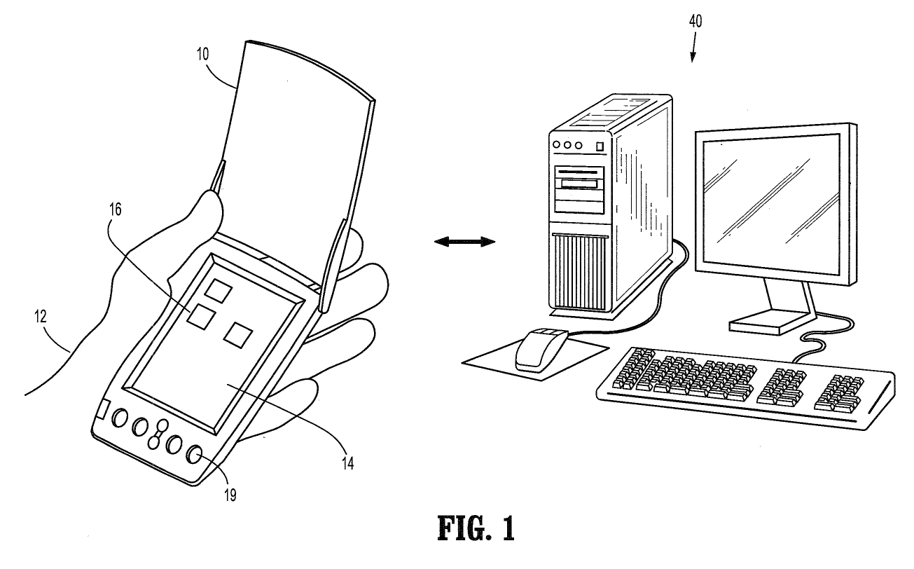

As such, a hand held mobile device having a virtual trackball that can control a mouse in a remote desktop computer easily, i.e., without modifying the server side in a client-server network computing relationship, has become a desirable device. This control relationship is depicted in FIG. 1, wherein mobile device 10, according to an exemplary embodiment of the present disclosure, is configured to remotely control desktop computer 40.

Referring now to FIGS. 1, 2 and 3, an overview of an exemplary embodiment of the present disclosure is provided.

FIG. 1 shows mobile device 10 that is adapted to be held in the hand of a user/operator 12 during use. Such mobile devices 10 include display screen 14, and may include manually actuated keys 19. Display screen 14 may be a touch screen that primarily controls the operation of mobile device 10. More particularly, several icons 16 are displayed on display screen 14, and programs or other functions are selected by touching an icon 16 that is displayed on display screen 14 corresponding to the program or function to be selected.

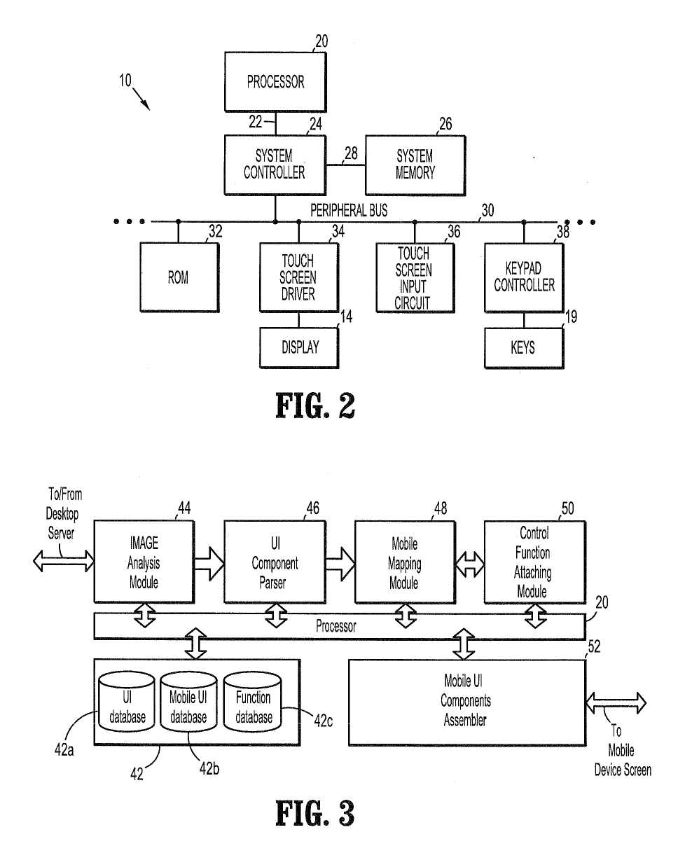

Basic components of the mobile device 10 are shown in the system block diagram of FIG. 2. Mobile device 10 includes processor 20 that is coupled through processor bus 22 to system controller 24. Processor bus 22 generally includes a set of bidirectional data bus lines coupling data to and from processor 20, a set of unidirectional address bus lines coupling addresses from processor 20, and a set of unidirectional control/status bus lines coupling control signals from processor 20 and status signals to processor 20. System controller 24 couples signals between processor 20 and system memory 26 via memory bus 28. System memory 26 is typically a dynamic random access memory (“DRAM”), but it may also be a static random access memory (“SRAM”). System controller 24 also couples signals between processor 20 and peripheral bus 30. Peripheral bus 30 is, in turn, coupled to a read only memory (“ROM”) 32, touch screen driver 34, touch screen input circuit 36, and keypad controller 38.

ROM 32 stores software programs for controlling the operation of mobile device 10, although software programs may be transferred from ROM 32 to system memory 26 and executed by processor 20 from system memory 26. Touch screen driver 34 receives information from processor 20 and applies appropriate signals to display screen 14 through touch screen driver 34. Touch screen input circuit 36 provides signals indicating that an action has been taken to select a program or function by touching a corresponding icon 16 (FIG. 1) on display screen 14. Keypad controller 38 interrogates keys 19 to provide signals to processor 20 corresponding to a key 19 selected by user/operator 12 (FIG. 1).

Referring now to FIG. 3, there is depicted a block diagram of various software modules executable by processor 20 of mobile device 10 to enable mobile device 10 to interface with and virtually control desktop computer 40 (FIG. 1).

Database 42 includes at least a UI database 42a which stores all existing detected UI components (e.g. image representations), a mobile UI database 42b which stores mobile UI data, and a function database 42c which stores function data.

Image analysis module 44 receives a set of UI components, such as icons, menus, and the like, from the display of desktop server 40, for display on display screen 14 of mobile device 10. In an exemplary embodiment a VNC® system that uses the RFB® protocol may be used to provide a graphical desktop sharing system between mobile device 10 and desktop server 40.

UI component parser 46 performs a scanning function that scans the display to detect one or more interacting objects of the image representation for the display screen 14. The interacting objects may include one or more of the following types: a URL, a menu of functions, a system icon, an application icon, a system button and an application button. The interacting objects may also include metadata and a bitmap.

Mobile UI mapping module 48 performs mapping to a pre-defined mobile UI.

Control function attaching module 50 invokes one or more functions contained in one or more activated icons. The control function can be implemented by one or more of the following approaches: an icon, a glyph, a trackball glyph, a pop up message and a pop up menu. The pop up message may include an instruction set. The control function permits navigation from a first interacting object to a second interacting object. The control function may be configured to select a subgroup of interacting objects.

Mobile UI components assembler 52 re-assembles detected UI components on top of the original remote desktop image on display screen 14 to provide the desired display.

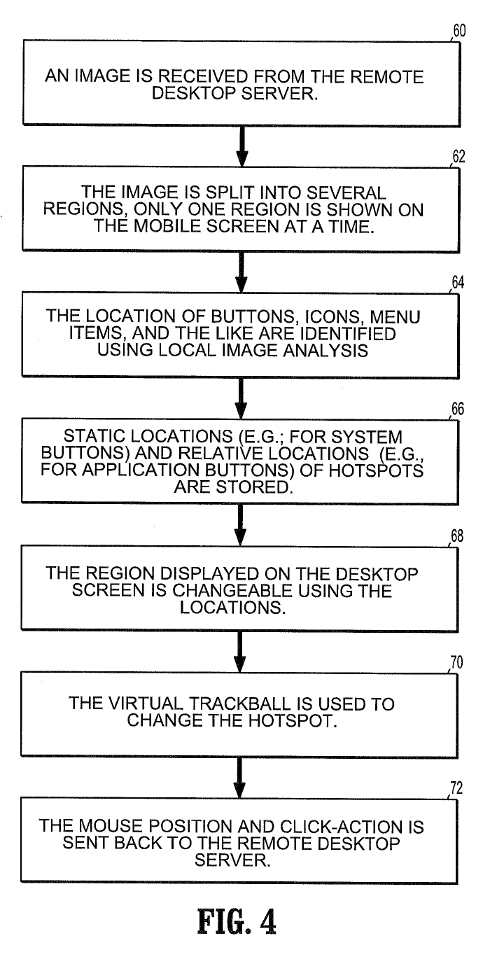

Referring now to FIG. 4, there is depicted an exemplary embodiment of the various functions which the software modules of FIG. 3 may perform.

In an exemplary embodiment an image is received from the remote desktop server (60). The image may be received image via standard VNC or RDP.

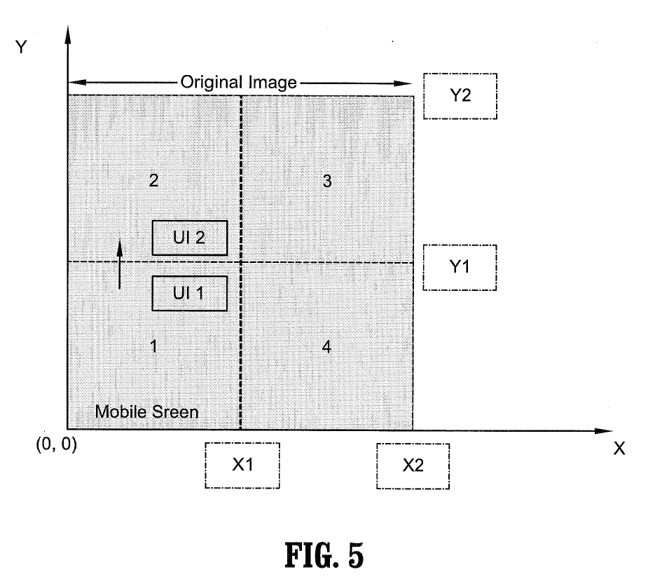

In an exemplary embodiment the image display on display screen 14 may be split into several regions, only one region being shown on the mobile screen at a time (62). The splitting may be implemented in various ways as needed. In an exemplary embodiment, referring briefly to FIG. 5, since the dimensions of received images and the mobile screen are known, the original image on the desktop display screen can be divided into various regions for the mobile display screen. In FIG. 5 an original image display on the desktop computer display screen can include regions 1, 2, 3, 4. Region 1 has x-coordinate dimensions extending from (0,0) to (X1,0) and y-coordinate dimensions extending from (0,0) to (0,Y1). Region 2 has x-coordinate dimensions extending from (0,Y1) to (X1,Y1) and y-coordinate dimensions extending from (0,Y1) to (0,Y2). Region 3 has x-coordinate dimensions extending from (X1,Y1) to (X2, Y1) and y-coordinate dimensions extending from (X1,Y1) to (X1,Y2). Region 4 has x-coordinate dimensions extending from (X1,0) to (X2,0) and y-coordinate dimensions extending from (X1,0) to (X1,Y1).

Referring back to FIG. 4, in an exemplary embodiment the location in a region of buttons, icons, menu items, and the like may be identified using local image analysis (64). Since displayed buttons and icons always have distinct adumbration, such adumbration can be used to calculate the locations of the buttons and icons.

In an exemplary embodiment static locations (e.g., for system buttons) and relative locations (e.g., for application buttons) of hotspots may be stored (66).

In an exemplary embodiment the region displayed on the desktop screen may be changeable using the identified locations (68). Detected interacting UIs (buttons, icons, etc.) are distributed in every region (for example, in FIG. 5, two desktop icons UI 1 and UI 2 are in region 1 and region 2, respectively). Since every detected UI component has rich metadata associated, a visual cue (e.g., a highlighted icon, a red box around the icon, and the like) can be attached to the icon to indicate gaining focus. When the visual cue's (x,y) exceed the mobile screen's boundary, a need to move to another region becomes known. For example, when a focus is moved from UI 1 to UI 2, the focus' y exceeds Y1, an impending move to region 2 becomes know, thus region 2 will then be displayed on the mobile screen.

In an exemplary embodiment a virtual trackball may be provided and may be used to change hotspots (70). The virtual trackball is a virtual input system designed for a touch screen mobile device. The virtual trackball has five clickable icons, i.e., 4 arrows and a ball icon in the middle. Each arrow points to one direction. The clickable icons operate as a virtual mouse which can be used to click on hotspots. By default, the arrows control the virtual mouse (i.e., the cursor) on the display screen, which is like any physical mouse input system. When the cursor is moved to the UI component, tapping the ball icon once acts the same way as clicking a left button of a physical mouse, tapping twice quickly acts as clicking the right button of a physical mouse, and then the associated menu or popup message will be displayed (mobile device menus, and the like). The virtual trackball input can switch to hotspot mode. The four arrow icons associate with the visual cue's (e.g., focus) movement, left, right, up and down. Thus, the user can quickly jump from one UI component to another (like the Blackberry® physical trackball system). After all UI components are detected, and associated with rich metadata, the virtual trackball can leverage these metadata, and navigate among those UI components (for example, jump from one clickable icon to another one without touching everywhere on screen, or zoom-in/out of the remote desktop image).

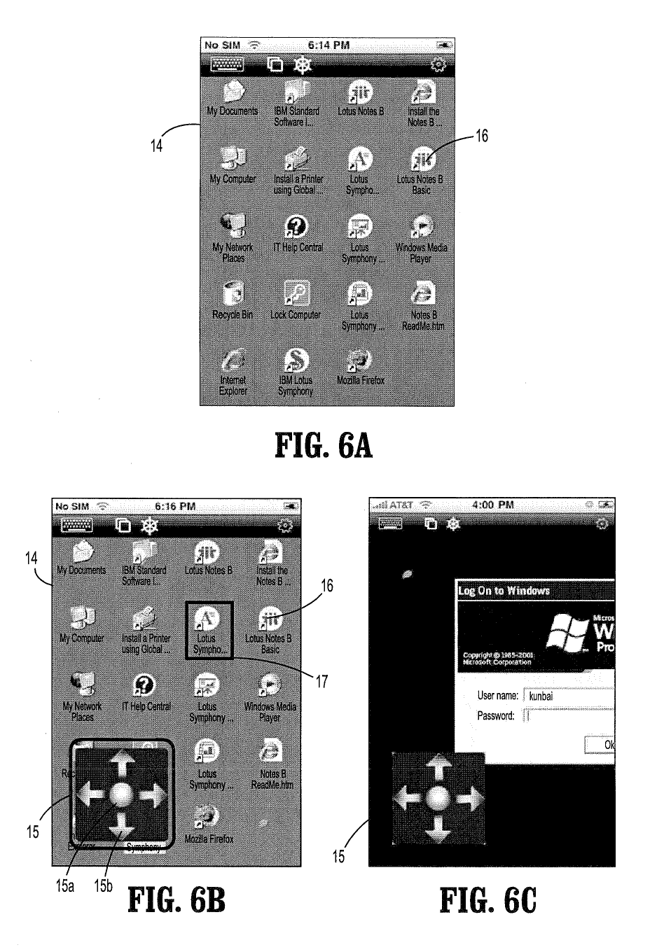

Referring to FIG. 6A, a representative display screen 14 showing various icons 16 is depicted. In FIG. 6B, the representative display screen 14 shown in FIG. 6A, includes exemplary virtual trackball 15 displayed on a portion of display screen 14. Virtual trackball 15 includes central trackball 15a and four location arrow buttons 15a. When the virtual mouse cursor 17 is about to cross the boundary of screen regions, for example from region 1 to region 2 as seen in FIG. 5, the next available screen region will smoothly slide onto the display screen 14. FIG. 6C shows display screen 14 the virtual trackball 15 displayed upon a portion of display screen 14 that is depicting a Log On box requesting a Log On password.

In an exemplary embodiment the mouse position and click-action may be sent back to the remote desktop computer via standard operations of the VNC or RDP protocols.

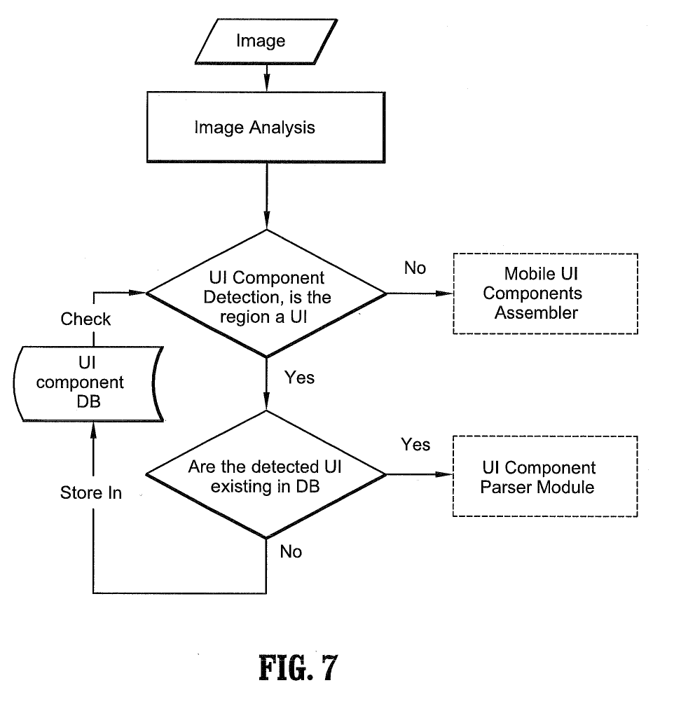

Referring now to FIGS. 7, 8 and 9, the operation of the software modules depicted in FIG. 3 is described in more detail.

Referring first to FIG. 7, a remote image may be received by the mobile device via VNC, or RDP, and given to local image analysis module 44 to detect all UI components, such as buttons, Icons, menus, etc. Any conventional image analysis algorithms which can be leveraged to detect UI components can be utilized. The UI component database locally stores all existing detected UI components (e.g. image representations). These stored UI components can be leveraged by image analysis algorithms to help define or conclude if an UI component is detected (for example, if one region being processed is the exact same as a stored UI component in the database, a UI component is detected). However, image analysis algorithms are not constrained by these existing UI components to detect a UI component. If a newly detected UI component is not in the UI component database, the database is updated with the newly detected UI component. The detected UI component is then passed to UI Component Parser Module 46.

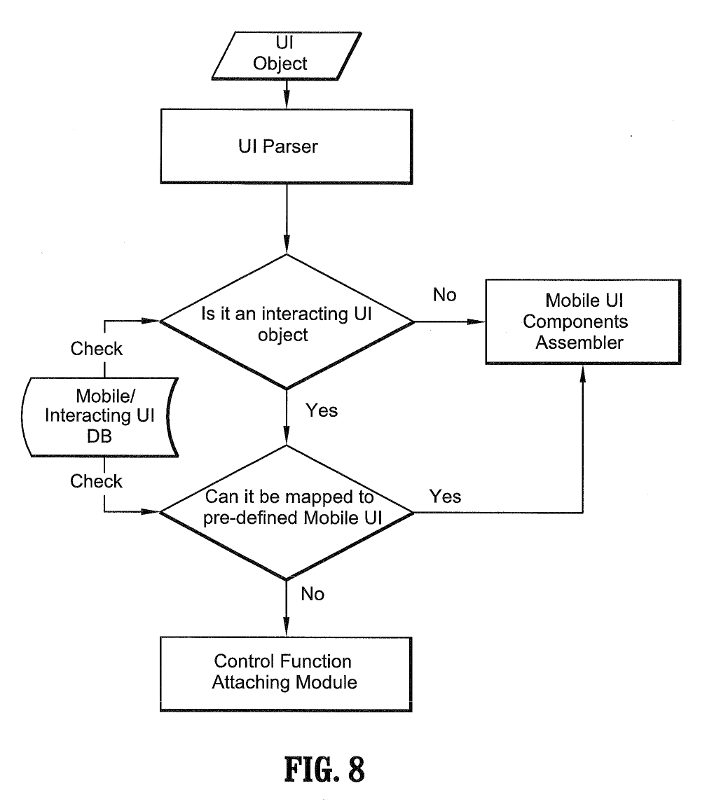

Referring now to FIG. 8, the operation of UI component parser module 46 and mobile UI mapping module 48 is described in more detail. A detected UI component is passed to UI component parser module 46. To determine if the UI component is an interacting UI object, the following is performed: If the UI component is already in UI component database 42a, all its metadata info is available (e.g., if the button is clickable, if the button is associated with right-click pop menu, etc, or if the button is just a close window button). These metadata can help determine if a UI component is an interacting UI object. For example, if its metadata is just a close window button, a typical UI component on every window interface, then it is a non-interacting UI object. Further processing (e.g., control function attaching) is not necessary and VNC, RDP can handle it in its usual way. If the UI component is not in the UI component database, any heuristic based machine learning algorithm can be applied to determine if the UI component is an interacting UI object, or suggest that the UI component be re-interpreted, or leave it. If the UI component can be mapped directly to a pre-defined mobile UI, it is associated with the mobile UI component. For example, if a Winamp media player running on the remote desktop gains the focus locally on the mobile device the associated mobile UI will be activated. If the UI component is not associated with a pre-defined mobile UI, it will be passed to control function attaching module 50 for further processing.

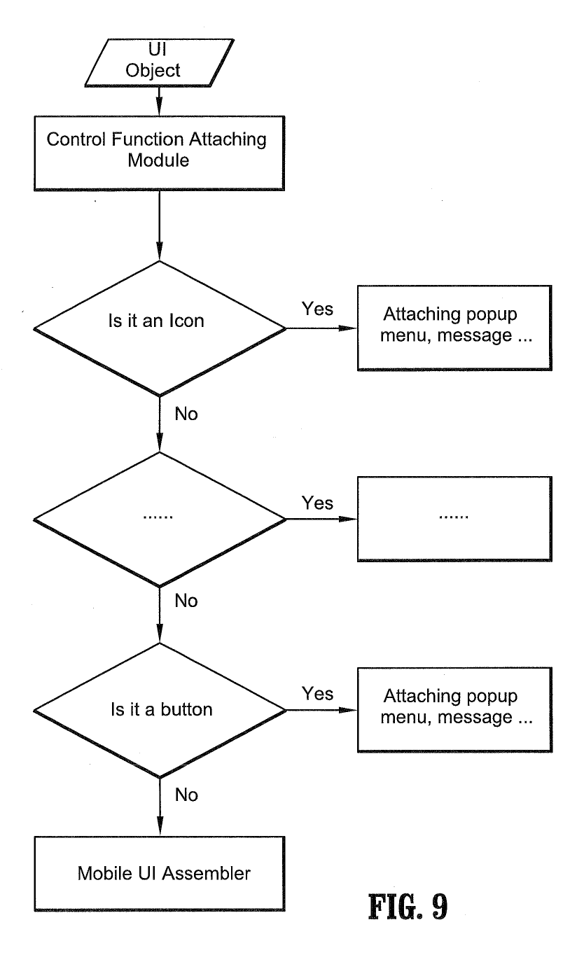

Referring now to FIG. 9, the operation of control function attaching module 50 and mobile UI components assembler 52 is described in more detail. A UI component is passed to control function attaching module 50. Control function attaching module 50 will attach right interaction functions to it based on its metadata. For example, if it is the “My Computer” icon, a right popup menu with function “Open”, “Search”, etc., will be associated with it, but in a mobile fashion when displayed (e.g., slide-up mobile system menu when the icon is right-clicked). All detected UI components will be passed to mobile UI components assembler module 52 to re-assemble on top of the original remote desktop image, but with rich metadata associated with each interacting UI component. When the remote desktop image via RDP/VNC is processing and detecting UI components, the UI component's position (center of the UI x, y), dimension information will be captured. When a processed UI object (with rich metadata, and control functions attached, etc) is passed to mobile UI assembler module 52, the module will link the original UI component's position, dimension information with this processed UI object, and thus generate a high level image representation. Therefore, when a gesture is made upon the UI component in original image (e.g., a tap, or 2 quick taps), the mobile virtual desktop system in accordance with the present disclosure will have the knowledge to respond correctly and accurately, such as responding to 2 quick taps with bringing up a slideup menu from the mobile screen with the exact same menu as originally seen in any PC based remote desktop application, but with a satisfying mobile user experience.

Those skilled in the art will appreciate that the mobile virtual desktop device in accordance with the present disclosure can cover all kinds of mobile devices that want to have remote desktop access capability (i.e., touch screen based, non-touch screen based devices like Blackberry® devices, and the like), and it provides a systematic method to re-interpret and represent the UI components embedded in a pure bitmap image received via VNC®/RDP protocol. By associating rich metadata with detected UI components, the mobile virtual desktop device in accordance with the present disclosure can increase the quality and satisfaction of the user interaction with remote desktop service in a purely mobile fashion.

The methodologies of embodiments of the present disclosure may be particularly well-suited for use in an electronic device or alternative system. Accordingly, exemplary implementations of the present disclosure may take the form of an entirely hardware embodiment or an embodiment combining software and hardware aspects that may all generally be referred to herein as a “processor”, “circuit,” “module” or “system.” Furthermore, exemplary implementations of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments of the present disclosure are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

For example, FIG. 2 is a block diagram depicting an exemplary processing system 10 formed in accordance with an embodiment of the present disclosure. System 10 may include a processor 20, memory 26 coupled to the processor (e.g., via a bus 28 or alternative connection means), as well as input/output (I/O) circuitry operative to interface with the processor 20. The processor 20 may be configured to perform at least a portion of the methodologies of the present disclosure, illustrative embodiments of which are shown in the above figures and described herein.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the present disclosure is not limited to those precise embodiments, and that various other changes and modifications may be made therein by one skilled in the art without departing from the scope of the appended claims.

1. A method for remote control of a desktop computer from a mobile device having a display, comprising:
receiving by the mobile device an image representation of a user interface of the desktop computer;
scanning the image representation to detect one or more interacting objects of the image representation;
generating on the display a display image having one or more of the interacting objects of the image representation; and
controlling the desktop computer by interacting with the one or more of the interacting objects of the display image and sending control information back to the desktop computer.

2. The method of claim 1, further comprising generating and associating metadata with one or more of the detected interacting objects of the image representation.

3. The method of claim 1, further comprising invoking one or more functions contained in one or more of the interacting objects.

4. The method of claim 1, further comprising configuring the display to display one of a plurality of regions of a replicated desktop computer display.

5. The method of claim 1, wherein the one or more interacting objects are icons and/or menus from a set of user interface components received by the mobile device, one or more of the set being activated user interface components having an activation status indicated.

6. The method of claim 3, further comprising invoking one or more functions contained in one or more of the activated icons.

7. The method of claim 1, wherein an image parser scans the image representation to detect the one or more interacting objects of the image representation.

8. The method of claim 1, wherein the interacting objects include one or more of a URL, a menu of functions, an system icon, an application icon, a system button and an application button.

9. The method of claim 3, wherein the one or more functions are invoked by one or more of an icon, a glyph, a trackball glyph, a pop up message and a pop up menu

10. The method of claim 3, wherein the one or more functions are invoked by a popup message.

11. The method of claim 9, wherein the popup message includes an instruction set.

12. The method of claim 1, wherein one or more of the interacting objects comprises metadata or a bit map.

13. The method of claim 1, wherein the mobile device is configured to navigate from a first interacting object to a second interacting object.

14. The method of claim 1 further comprising selecting a subgroup of interacting objects.

15. The method of claim 15 wherein the subgroup uses the entire display.

16. The method of claim 1, further comprising displaying a virtual trackball on the display, the virtual trackball configured to interact with the one or more interacting objects.

17. A non-transitory computer program storage device embodying instructions executable by a processor to perform remote control of a desktop computer from a hand held mobile device having a display, comprising:
instruction code for receiving by the mobile device an image representation of a user interface of the desktop computer;
instruction code for scanning the image representation to detect one or more interacting objects of the image representation;
instruction code for generating on the display a display image having one or more of the interacting objects of the image representation; and
instruction code for controlling the desktop computer by interacting with the one or more of the interacting objects of the display image and sending control information back to the desktop computer.

18. The non-transitory computer program storage device of claim 17,
wherein the display is a touch screen display for both display and for desired entry input, and
wherein the non-transitory computer program device further comprises instruction code for configuring a touch screen display of the mobile device to display one of a plurality of regions of a replicated desktop computer display.

19. The non-transitory computer program storage device of claim 17,
wherein the display is a touch screen display for both display and for desired entry input, and
wherein the non-transitory computer program storage device further comprises instruction code for displaying a virtual trackball on the display, the virtual trackball configured to interact with the one or more interacting objects.

20. A mobile device for remote control of a desktop computer, comprising:
a hand-held mobile computer processing device having a display; and
a non-transitory computer program storage device configured to interact with the hand-held mobile computer processing device to provide a user an ability to control a remote desktop computer by the mobile device,
wherein the non-transitory computer program storage device comprises:
instruction code for receiving by the mobile device an image representation of a user interface of the desktop computer;
instruction code for scanning the image representation to detect one or more interacting objects of the image representation;
instruction code for generating on the display a display image having one or more of the interacting objects of the image representation; and
instruction code for controlling the desktop computer by interacting with the one or more of the interacting objects of the display image and sending control information back to the desktop computer.

21. The mobile device of claim 20,
wherein the display is a touch screen display for both image display and for desired entry input, and
wherein the non-transitory computer program device further comprises instruction code for configuring a touch screen display of the mobile device to display one of a plurality of regions of a replicated desktop computer display.

22. The mobile device of claim 20,
wherein the display is a touch screen display for both image display and for desired entry input, and
wherein the non-transitory computer program storage device further comprises instruction code for displaying a virtual trackball on the display, the virtual trackball configured to interact with the one or more interacting objects.

23. A method for remote control of a desktop server from a mobile device having a touch screen display screen for displaying an image of the desktop server and for desired entry input by a user, the method comprising:
receiving an image from the remote desktop server;
splitting an image display on the touch screen display screen into several regions, only one region being shown on the touch screen display screen at a time;
identifying and storing locations in a region of one or more interacting objects using local image analysis;
configuring the display on the touch screen display screen such that a region displayed is changeable using identified locations;
providing a virtual trackball configured for changing hotpots, the virtual trackball having clickable icons for controlling a cursor on the touch screen display screen; and
sending back cursor position and click-action to the desktop computer.
